(19) United States
(12) Patent Application Publication
(10) Pub. No.: US 2009/0184829 A1
(43) Pub. Date: Jul. 23, 2009

(54) TEMPERATURE SENSOR

(76) Inventor: Cecil Rivers, JR., Hartford, CT (US)

Correspondence Address: General Electric Company;GE Global Patent Operation, PO Box 861, 2 Corporate Drive, Suite 648, Shelton, CT, 06484, US

(21) Appl. No.: 12/017,722

(22) Filed: Jan. 22, 2008

(51) Int. Cl. G01K 3/00; G08B 17/00

(52) U.S. Cl. 340/584; 374/137; 374/E03.001

(57) ABSTRACT

The present disclosure describes an apparatus and method for monitoring a thermal profile proximate a housing, the apparatus comprising at least one temperature sensor supportable by the housing and configured for monitoring a thermal profile proximate the housing, at least one thermoelectric generator in circuit with the at least one temperature sensor and configured to provide electrical energy sufficient to power the at least one temperature sensor, and an indicator device in circuit with the temperature sensor and configured to provide at least an indication where the thermal profile is outside a predetermined thermal profile range.

### BACKGROUND

The present invention relates to an apparatus and method for sensing temperature. More specifically, the invention relates to an apparatus and method for monitoring a thermal profile proximate a housing.

Housings that contain heat-generating elements are generally manufactured with certain design requirements. Some housings may, for example, be operable within certain temperature ranges and if the internal temperature of the housing falls outside of the range, damage to the interior elements may occur. Currently, to identify the thermal profile of such a housing, users may be required to set up thermal cameras or place thermocouples throughout the housing. Both of these options can be costly, inefficient and may require their own source of power.

One example of a housing that contains heat-generating elements is a circuit breaker unit. Overheating of circuit breakers is a costly problem that leads to inefficiency and even loss of human life through electrocution and fire. Problems with circuit breaker units generally arise through defective assembly, improper wiring post-installation, attempts to add additional equipment, overloading the panel, or because the panel was not modified when non-linear loads were added. Furthermore, many panels have small lugs that necessitate small wiring, which is a source of frequent overheating. The neutral bus also has the tendency to overheat, which causes damages to the bus. Because overheating of a panel is one of the first signs of a problem, it is important to continuously and effectively monitor the panel for signs of overheating so that the problem maybe addressed and corrected as soon as possible, which is particularly important if the neutral bus begins to overheat. It is additionally beneficial to be alerted of a possible problem before an overload occurs and the circuit is blown, because once blown, the problem must be located and fixed before the breaker can be reset.

Monitoring of circuit breaker units have been described, for example in U.S. Pat. No. 5,270,658 which describes a monitoring module which monitors the properties of a circuit breaker panel such as voltage surge and temperature. However, to measure temperature, the module incorporates the use of temperature sensor transducers, each having to be plugged into jacks and incapable of operating without utilizing electrical power from an outside source. Temperature sensor transducers may become costly in part because they require many sensors to be placed throughout the unit. Furthermore, this solution may become particularly expensive in large commercial units because of its use of outside electrical power.

Accordingly, to date, no suitable device or method of monitoring a thermal profile proximate a housing is available.

### BRIEF DESCRIPTION

The present disclosure describes a apparatus and method for monitoring the thermal profile of a housing. One particular advantage afforded by embodiments of the present invention is the ability to power a monitoring device that monitors the thermal profile of a housing the inherent thermal properties of the housing.

In a first embodiment, the invention provides an apparatus for monitoring a thermal profile proximate a housing, the apparatus comprising at least one temperature sensor supportable by the housing and configured for monitoring a thermal profile proximate the housing, at least one thermoelectric generator in circuit with the at least one temperature sensor and configured to provide electrical energy sufficient to power the at least one temperature sensor, and an indicator device in circuit with the temperature sensor and configured to provide at least an indication where the thermal profile is outside a predetermined thermal profile range.

In a second embodiment, the invention provides a method for monitoring a thermal profile proximate a housing, the method comprising utilizing a temperature gradient to power a temperature sensor, sensing a thermal profile proximate the housing via the temperature sensor, and indicating to an operator where the thermal profile of the housing is outside a predetermined range.

Other features and advantages of the disclosure will become apparent by reference to the following description taken in connection with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an electrical circuit in accordance with one embodiment to which the present invention relates;

FIG. 2 is diagrammatic representation of an exemplary housing to which embodiments of the present invention relates;

FIG. 3 is a flow chart describing a stepwise method in accordance with a further embodiment of the present invention.

Like reference characters designate identical or corresponding components and units throughout the several views, which are not to scale unless otherwise indicated.

### DETAILED DESCRIPTION

One embodiment of the present invention involves a temperature sensor circuit that comprises a thermoelectric generator for energizing a temperature sensor that, in turn, is connected to an indicator device. One particular advantage afforded by this embodiment is the ability to provide a monitoring device that monitors a thermal profile proximate a housing ambient thermal energy without being connected to a source of electrical energy.

Specific configurations and arrangements of the claimed invention, discussed below with reference to the accompanying drawings, are for illustrative purposes only. Other configurations and arrangements that are within the purview of a skilled artisan can be made, used, or sold without departing from the spirit and scope of the appended claims. For example, while some embodiments of the invention are herein described with reference to circuit breaker units, a skilled artisan will recognize that embodiments of the invention can be implemented in any housing that exists a temperature gradient large enough to power a thermoelectric generator where thermal profile monitoring is advantageous.

For example, some non-limiting housings the present invention may be applicable include: circuit breaker units, computers, or televisions.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

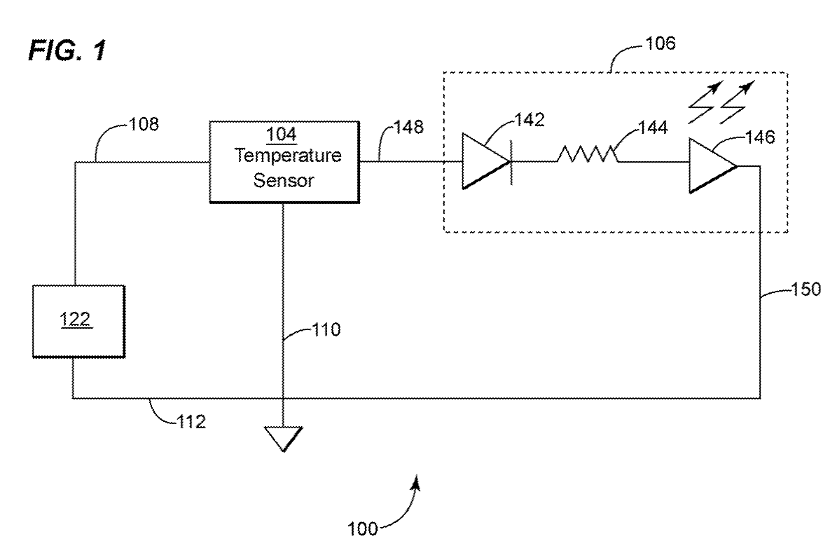

Referring now to FIG. 1, an exemplary temperature sensor circuit corresponding to one embodiment of the present invention is shown generally at 100. The temperature sensor circuit 100 comprises a thermal electric generator 102, a temperature sensor 104 and an indicator device 106.

The thermoelectric generator 102 is connected via a line 108 to the temperature sensor 104 and to a ground wire 110 via a line 112. It will be appreciated that the thermoelectric generator 102 provides a source of electrical current by converting a temperature gradient into an electric current (or vice versa) via the Peltier-Seebeck effect. The thermoelectric generator 102 may comprise any known thermoelectric generator device such as that sold under the trademark TEG POWER MODULE and available from the Thermal Electronics Corporation.

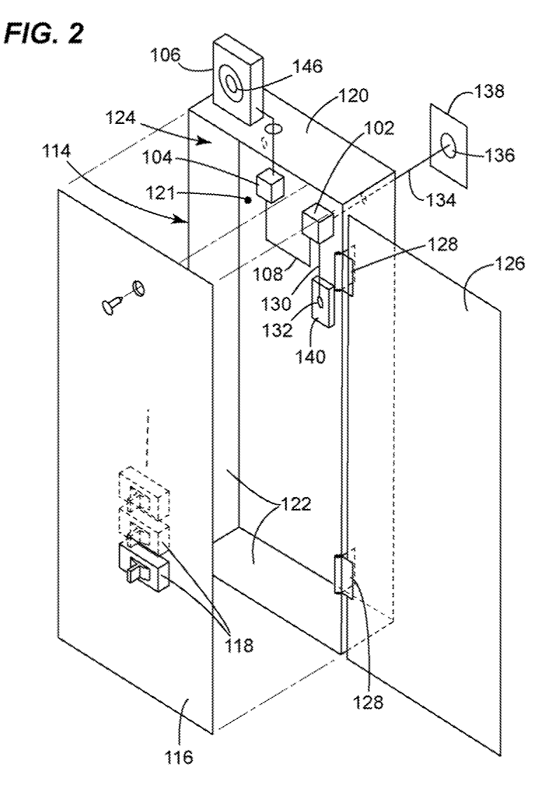

Referring now also to FIG. 2, the thermoelectric generator 102 may be mounted to a housing 114. The housing 114, as illustrated, comprises a circuit breaker panel 116 supporting circuit breakers 118, although, it will be understood that any housing, for residential and/or nonresidential use and, containing, e.g., electrical and/or non-electrical devices, wires, processors, circuit boards and the like for which over-temperature monitoring is desired, may be employed in the practice of the exemplary embodiment. The housing 114 also comprises an enclosure 120 comprising a back plate 121 and walls 122 that together define a cavity 124. A door 126 may be coupled to the enclosure 120 via hinges 128.

The thermoelectric generator 102 comprises a first electrode wire 130 terminating in a first electrode 132 and a second electrode wire 134 terminating in a second electrode 136. In accordance with a feature of the invention, the two electrodes 132 and 136 are advantageously located at positions most likely to sustain the greatest temperature gradient, e.g., one within the cavity 124 of the housing 114 where internal heat generating elements, such as the circuit breakers 118 and wires (not shown) are located and the other being located outside the cavity and, as shown, e.g., to a separate structure 138. The electrode 132 may be connected to a heat sink 140 that may be provided to stabilize the temperature fluctuation of the back plate 121 during operation of the thermoelectric generator 102, especially, where the back plate comprises a sheet metal such as a steel.

As used herein, the term “thermoelectric generator” is meant to include any device capable of converting a temperature gradient into an electrical current. It is to be appreciated that the thermoelectric generator 102 may comprise a plurality of thermoelectric generators placed at effective positions throughout the housing where necessary to provide sufficient power for operating the temperature sensor circuit 100.

The temperature sensor 104 may comprise one or more contact temperature sensors, non-contact sensors or any combination thereof. For example, a non-contact temperature sensor that may measure infrared radiation from a particular surface area or volume within the cavity 124 may be employed. A temperature sensor suitable for use in the practice of this embodiment is sold under the trademark RAYTEK sold by the Watlow Corporation.

The temperature sensor 104 is configured to monitor a thermal profile within the cavity 124. Because, in this embodiment, the cavity 124 contains largely all the electrical circuitry of the unit, it would be expected to generate the largest gradient from inside the cavity to the panel 116. Furthermore, because overheating circuitry is itself the foremost cause of blown circuits it is beneficial to monitor the thermal profile of the cavity 124.

While not shown, one or more contact temperature sensors may be attached to directly to wires or structures that are not easily monitored by the non-contact temperature sensor.

The indicator device 106 may comprise a breakdown diode 142, a resistor 144 and an indicator 146. In this particular exemplary embodiment, the breakdown diode 104, the resistor 144 and the indicator 146 are connected in circuit between the temperature sensor 104 and the ground 110 via lines 148 and 150. The breakdown diode 142 may comprise a zener or avalanche diode that permits current to flow where an applied voltage is larger than a breakdown voltage. It will be appreciated that the breakdown diode 142 may be varied to produce a predetermined temperature at which the indicator 146 may be energized. In one optional embodiment, resistor 144 may comprise a variable resistor controlled by an operator to vary a temperature at which the indicator 146 will be illuminated.

The indicator 146 may comprise a visual indicator such as a light emitting diode (hereinafter “LED”), halogen lamp, or a mechanical flag. In other embodiments, the indicator 146 may comprise an auditory indicator such as a buzzer, or a communication port for a transmission of status. The indicator is configured to signal an operator when the thermal profile of the housing has fallen outside a predetermined thermal profile range. As used herein the term “operator” may comprise a technician, a user, a bystander, a homeowner, etc. As used herein, the term “predetermined thermal profile parameters” or “predetermined thermal profile range” is intended to mean the either chosen or recommended temperature ranges that the internal components of a housing are meant to function. For example, the temperature range of an electrical circuit breaker unit may be meant to function most effectively at between 85-90 degrees Fahrenheit, e.g., if the temperature were either below 85 or above 90 degrees, it would be outside the thermal profile parameter or range. Also, it may encompass upper or lower bounds, e.g., above or below 90 degrees Fahrenheit. Furthermore, thermal profile ranges may be given by the designers of the housing, or may be chosen by the operator.

In operation, the indicator 146 may be activated, for instance, when the voltage flow coming from the diode 142 reaches the indicators required voltage level. Thus, the operator is further able to control at what temperature he/she would like to be alerted. The operator can turn a selector switch on the module that selects diodes of different values which each diode corresponds to a different temperature level. If the resistor is used to change the temperature level, then the operator will adjust a potentiometer.

In another embodiment, the indicator 146 may provide a continuous indication of the thermal profile of the cavity 124. For example, a digital meter, an analog panel, or a bar graph panel may be used to continuously indicate the temperature inside particular sections of the housing. Furthermore, if more than one sensors is used, separate indicators 146 may be paired to separate sensors. Alternatively, temperature sensor 104 may comprise a thermal infrared imager which may be in circuit with a video display showing the housing in thermal light. An advantage to both the above techniques is the ability to view the temperature in real-time. By “real-time” is meant that the profile of the housing is shown continuously and instantaneously on a monitor.

In another embodiment, the invention provides a method for monitoring a thermal profile proximate a housing comprising utilizing a temperature gradient to power a temperature sensor, sensing a thermal profile proximate the housing via the temperature sensor, and indicating to an operator where the thermal profile of the housing is outside a predetermined range.

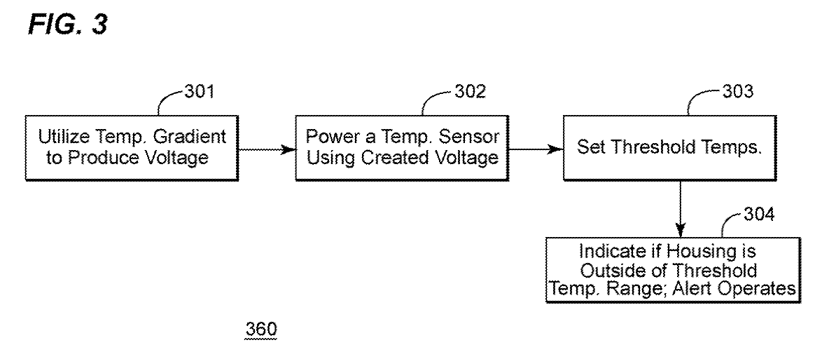

With reference to FIG. 3, there is shown a flowchart to better help illustrate this exemplary method. While the flowchart shows an exemplary step-by-step method, it is to be appreciated that a skilled artisan may rearrange or reorder the steps while maintaining like results.

Utilization of a temperature gradient step 301 to power a temperature sensor step 302 occurs by the use of a thermoelectric generator. In this exemplary embodiment, a thermoelectric generator may be disposed on the cavity of a circuit breaker unit. Typically, circuit breaker units produce internal heat via the current running through the many circuits. Also, circuit overload will produce even greater internal heat than is typical. Therefore, the thermoelectric generator may utilize the temperature gradient from a first side of the breaker unit, e.g., the internal side of the faceplate, and a second side of the breaker unit, e.g., the ambient room temperature side of the faceplate. For example, the ambient temperature outside the housing may be at 75 degrees Fahrenheit, while the internal temperature housing may be at 90 degrees Fahrenheit. The thermoelectric generator, through the thermoelectric effect, is able to directly convert the temperature difference into an electric voltage. This is referred to in the art as the “Seebeck Effect” which is that a voltage, i.e., the thermoelectric EMF, is created in the presence of a temperature difference between two different metals or semiconductors which causes a continuous current to flow in the conductors if they form a complete loop. Generally, the voltage created is of the order of several microvolts per degree difference in the gradient.

In this particular embodiment, the temperature sensing step 302 may utilize the voltage created to power an at least one temperature sensor. The temperature sensor is, for example, a non-contact temperature sensor that utilizes the known area of the housing and measures the IR radiation given off by the internal components of the housing.

In step 303, the threshold temperatures are chosen. This may be done before hand according to manufacturing guidelines, or may be chosen pre or post-installation by an operator. The threshold temperatures may be altered at any time via diode alteration.

The indicating step 304 may comprise the use of a visual or auditory indicator. In one exemplary embodiment, an LED is used to indicate the housing is outside of a chosen threshold temperature value. In an accompanying embodiment, an auditory signal such as a an alarm is used to indicate to the operator that the temperature is outside of a chosen threshold value.

The abovementioned method may be utilized, for example, to monitor the thermal profile of an electrical circuit breaker unit, which because of overloading and other defects, are prone to overheat.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

What is claimed is:

1. An apparatus for monitoring a thermal profile proximate a housing, the apparatus comprising:
at least one temperature sensor supportable by the housing and configured for monitoring a thermal profile proximate the housing;
at least one thermoelectric generator in circuit with the at least one temperature sensor and configured to provide electrical energy sufficient to power the at least one temperature sensor; and
an indicator device in circuit with the temperature sensor and configured to provide at least an indication where the thermal profile is outside a predetermined thermal profile range.

2. The apparatus of claim 1, wherein the housing comprises a cavity and at least one electrical circuit breaker is disposed within the cavity and wherein the at least one temperature sensor is configured for monitoring the thermal profile within the cavity.

3. The apparatus of claim 1, wherein the indicator device further comprises a breakdown diode in circuit with a resistor and an indicator.

4. The apparatus of claim 1, wherein the indicator may comprise one or more of a visual indicator, an auditory indicator or a combination thereof.

5. The apparatus of claim 1, wherein the indicator provides a continuous indication of the thermal profile.

6. The apparatus of claim 1, wherein the thermoelectric generator comprises a first electrode that is positioned within the cavity of the housing and a second electrode positioned outside of the cavity.

7. The apparatus of claim 1, wherein the predetermined range may be varied.

8. The apparatus of claim 1, wherein the thermoelectric generator comprises a heat sink.

9. A method for monitoring a thermal profile proximate a housing, the method comprising:
utilizing a temperature gradient to power a temperature sensor;
sensing a thermal profile proximate the housing via the temperature sensor;
indicating to an operator where the thermal profile of the housing is outside a predetermined range.

10. The method of claim 9, wherein the housing comprises a cavity and at least one electrical circuit breaker disposed within the cavity and wherein the at least one temperature sensor is configured for monitoring the thermal profile within the cavity.

11. The method of claim 9, wherein utilizing a thermal gradient comprises configuring a thermoelectric generator to use a thermal gradient created between inside a cavity of the housing and outside thereof.

12. The method of claim 9, wherein indicating to an operator comprises providing a visual indicator, an auditory indicator or any combination thereof.

13. The method of claim 9, wherein the indicator provides a continuous indication of the thermal profile.

14. The method of claim 9, wherein the predetermined thermal profile range may be varied.
